(19) United States
(12) Patent Application Publication
(10) Pub. No.: US 2016/0133135 A1
(43) Pub. Date: May 12, 2016

(54) LIGHT-SOUND WARNING SYSTEM FOR PARTICIPANTS IN ROAD TRAFFIC

(71) Applicant: Vojislav ILIEV, Bregana (HR)

(72) Inventor: Vojislav ILIEV, Bregana (HR)

(21) Appl. No.: 14/897,375

(22) PCT Filed: Nov. 8, 2013
(86) PCT No.: PCT/HR2013/000033

§ 371 Date: Dec. 10, 2015

(30) Foreign Application Priority Data
Jun. 12, 2013 (HR) P20130542A

(51) Int. Cl. G08G 1/16; B60Q 3/02; B60Q 1/52; B60Q 5/00

(52) U.S. Cl. CPC G08G 1/162; B60Q 5/005; B60Q 3/0293; B60Q 1/52

(57) ABSTRACT

Light-sound warning system of all participants in road traffic is disclosed which solves the problem of safe and reliable signaling of a pedestrian on the road. A driver who saw a pedestrian on the road activates the switch which transmits the information to other vehicles via radio signals, and signals to pedestrians with light and audio signals that there is a vehicle approaching. This system protects both the pedestrian, and the driver who first spotted the pedestrian because a second vehicle driving behind the first vehicle often does not observe the situation in time causing a collision with both the vehicle and the pedestrian. The system is realized by connecting the following elements installed inside the vehicle: the central unit, the receiving-transmitting unit, the switch, the interior light signals, external audio signals and the internal sound signals; while the exterior light system is installed on the outer periphery of the vehicle.

### TECHNICAL FIELDS OF THE INVENTION

The invention according to the International Patent Classification belongs to a group G08G 1/00, which includes systems for road traffic control and the same in the group B60Q 1/52, which includes systems or signaling devices or light to indicate emergency situations.

### TECHNICAL PROBLEM

In terms of rapid growth of the world population, where in year 2028 there will be eight billion people living on Earth, and in year 2054 nine billion people (Source: Population Reference Bureau and the UN), and the increasing trend of population growth in urban areas (by year 2030, 60% of the world's population will live in cities), and will result in the creation of mega-cities.

Even more rapid development of technology is used in the construction of high and unusual buildings in combination with the growing migration of population to the cities, leading to a “population explosion” in the cities. The mega-cities such as Mexico City, Lagos, Shanghai, Mumbai, Cairo, as well as among all the other cities of the world, almost exponentially generate direct and indirect losses due to the high traffic, as well as increased risks of accidents. In regards to that, traffic accidents pose large damage costs, and can irreparably harm as a loss of human life.

Recognizing the bad side and today trends in the world, measures aimed at reducing the negative trend of traffic accidents are increasingly taking place. Plan and initiative of the European Commission in the field of technology, implementation, education, and attention particular paid to the most vulnerable road users, especially pedestrians and cyclists, is drastic reduction in further loss of human lives.

The main recommendation of the European Commission and its main goal is to halve the number of casualties on the roads by 2020, and by the 2050 approach zero the number in road traffic accidents with fatal consequences. The vision of the European Commission's road safety without casualties arising from the main activities related to direct special attention to the implementation of specific measures and solutions in road transport which would protect as many road users such as pedestrians, cyclists and motorcyclists, primarily through improving safer technology vehicles. Occasional incidents the road traffic often result in material damage and bodily injury, and often are fatal. Examples of such incidents situation are: children run across roads or marked pedestrian crossings, pedestrian run across the road, pedestrians moving in front of the bus stopping at the bus stop, groups of pedestrians moving across the road, pedestrian lying on the road or the situation immediately after accidents including motorcycles, vehicles and pedestrians.

The problem that arises here is how timely signal traffic participants for the existence of a situation in which the pedestrian is on the road, and for drivers to respond as soon as possible. In fact, it often just happens to the driver of vehicles that is located behind the vehicle of which the driver who saw a pedestrian on the road did not notice it on the road and hits a car in front the one that has stopped for pedestrian.

The current situation whereby vehicles ahead commonly observed pedestrians or slow down (this can be done by braking, releasing the acceleration pedal or shifting to a lower gear), or they can turn on warning lights (usually direction lights). But in neither one of these actions drivers of other vehicles that are moving behind the vehicle which detected pedestrians on the road is not a reliable and unambiguous manner signaled that it was precisely the situation where the pedestrian has been noticed on the road. Namely, if a vehicle/driver that has observed pedestrian, slows the speed of the vehicle, it does not mean that the drivers of other vehicles or the pedestrian noticed slowing down of the vehicles, because as stated earlier, vehicle can slow down releasing the accelerator pedal or shifting to a lower gear, in respect of which drivers of other vehicles might have wrong perception on the information or actions that drivers is performing. Likewise, if there as a situation where, immediately after the vehicle there is a larger vehicle (transport vehicle, bus, truck, etc.) driving, the driver behind that larger vehicle are without visibility and awareness of the situation on the road ahead of them, particularly when the pedestrians are on the road.

### STATE OF TECHNOLOGY

Current common practices of the signals for vehicles that recognize pedestrians in front of the vehicles, do not have the technical ability to send specific signals and alert other vehicles behind that pedestrian is on the road, unless driver presses the brake pedal, which turns the rear stop light or turn position lights, but it still does not report that on the road pedestrian has been noticed, but only the need to reduce speed, and necessity increase caution while driving.

Former patented inventions for signaling and detection of incidents on the road, which are perceived in the direction of the driver of the vehicle; certain sensors or video cameras are based on the signaling of such incidents only to vehicles without a signal carried by pedestrians, cyclists and motorcyclists.

European patent application EP 0627719A2 protected invention includes a communication channel between the two vehicles through which conveys information about the dangers on the road, where the driver of the vehicle which meets danger selects one of four different switches (depending on the type of danger that he wants to warn others road users), with each button represents a different signaling vehicle that receives the signal and on the basis that include the vehicle cabin lights whose color give meaning to a particular situation (e.g. one type of light for the road works, the other for the accident and so on). However, the difference with the invention of light-sound warning system for participants in road traffic is that the invention claimed in the above-cited patent application does not include components for outdoor sound and light signaling system and a limited menu of situations that the driver must choose so that the same information is transferred to other vehicles.

German patent application DE4004816A1 protects the invention in which the connection passes through radio signal that includes all 4 encoder position (where the frequencies used by commercial FM and AM radio), which is desirable in the case of reduced visibility, but it is not specifically the signs of the presence of pedestrians on the road.

### BRIEF DESCRIPTION OF THE INVENTION

This invention solves the primary problem of safe and reliable signaling to other vehicles on the road when a pedestrian is in the way to a vehicle driver who saw the pedestrian on the road by turning the switch of the light-sound warning system to all participants in road traffic; and signals other vehicles that have installed same system for the presence of pedestrians on the road, whether a pedestrian crosses the road, or for any other reason is to it. Furthermore, this system resolves the problem of colliding with vehicle that is behind the vehicle which has detected pedestrians, and the fact that the driver of the vehicle due to the signs of the vehicle in front of the one is not noticed at the time, the situation whereby result with colliding with the vehicle in front and possible collision with the pedestrian.

A secondary problem to be solved by this invention is a recording of the time in which the driver of the vehicle saw pedestrians on the road and the time when the other vehicles have received the signal, which allows for easier reconstruction behavior of vehicles in traffic in the event of an incident, especially when vehicles collides with pedestrians.

Usefulness of the invention is the fact that the pedestrian is protected from direct collision of the moving vehicles behind the vehicle which has detected the pedestrian, reduces damage cost to the insurance companies, and also affects driver's safety in traffic because it reduces the possibility of an accident with serious consequences.

From the statement above, car industry will gain additional business and would increase employment. Light-sound warning system for all participants in road traffic, ensures greater security to vulnerable participants in road traffic as it uses the latest scientific findings regarding the unfolding process in which human/driver reacts to danger. Specifically, process resulting in traffic hazards is a process that consists of two phases. The first phase consists of time perception and time perception of risk, driver response time, and the time in which he began braking. However, in the first phase, the brake system still does not perform its function. The second phase covers the time from activation of the brakes to final stop the vehicle.

When a particular hazard on the road, it takes some time until the driver becomes aware of the danger. Subsequently, it has been proven, when the driver becomes aware of the dangers, the driver's reaction will be faster by hand, rather than with the foot. Studies have shown that the reason why we react first hand, and after that by foot is in the center of mobility, which is located in the brain, to which center for congenital recognition automatically gives a certain group of muscles near the brain command to perform a specific action requested or reaction. Given is the reason for the need of installing a switch to activate the light and sound signaling near the steering wheel of the vehicles or close to hand, and not to be integrated into the existing system to brake by pressing the foot brake. Reaction with hand will be faster with hand that is used (right for right-handed and left for left handed). Even reaction with either hand will be faster than the reaction of the left or right foot.

Through mechanical activation of the switch located near the steering wheel, driver controls the activation, the central unit sends a control signal to reception-transmission unit which forwards the signal that the pedestrian that is on the road through the radio link (electromagnetic waves) to the destination-transmitting equipment of other vehicles within approx. 70 meters radius, which has been proved to be the optimal distance for the assuring required minimum stopping of the vehicle, but also for preventing the transmission of the radio signal warning of the presence of pedestrians to the wider range which might create confusion in traffic. On the basis of the received signal, central unit installed in other vehicles that received signal turns on the internal signaling and internal sound signal in the cabin of the vehicle, which signals the presence of pedestrians on the road to the driver of the vehicle.

In addition to activating the switch and signaling the presence of pedestrians on the road to vehicles at a distance of approx. 70 meters; external light signals and external audio signals are triggered on the vehicle that has started the signal transition in order to warn the pedestrians of the incoming vehicle.

Elements of light-sound warning system for all participants in road traffic are installed in each vehicle and consist of the same central unit, the receiving-transmitting unit, switch, external lights, interior lights, the external audio signals and an internal audio signal. The system as such will be installed in new vehicles during the manufacturing process, and it can also be installed in existing vehicles. The central unit can be installed in existing vehicles, or it can be integrated together with the trip computer of the vehicle in new vehicles. Receiver transmitter unit is running as a transmitter and receiver in the VHF band with the provision to sends coded radio signal to avoid interaction with other signals and systems, and in the preferred version it is connected with a wire to an external antenna of the vehicle in order to ensure good distribution of the signal or reception of a signal.

External light signaling is commonly implemented through 6 sources of warning lights which are installed in pairs on the front and rear of the vehicle, and one light source on the left and right side of the vehicle. External sound signaling in a preferred design performs as a horn that produces a specific identifiable sound. Internal sound signaling is implemented through the existing vehicle audio signals; while the interior lights are commonly executed as flashing lights installed on the dashboard of vehicles in the driver's field of vision. The central unit will in the best installment perform as part of an existing vehicle computer, and the receiver-transmission unit will be placed (4) in its vicinity in order to provide secure and firm connection to the central unit through a wire connection. The central unit in the vehicle with the activated switch stores information about the activation time, and also the central unit is receiving the signals from other receiving-transmitting units in other vehicles about the presence of pedestrians, and memorize the specified time of the reception of such. Data on these times are of significant assistance in the reconstruction of driver behavior in traffic incidents, particularly in the case of collisions of vehicles and pedestrians.

### BRIEF DESCRIPTION OF THE DRAWINGS

Pictures describe systems and components in accordance with the invention, and can be used as an example but not as a limitation. The labels in the drawings denote described parts or those resembling them.

FIG. 1. Conceptual scheme of the light-sound warning system of all participants in road traffic

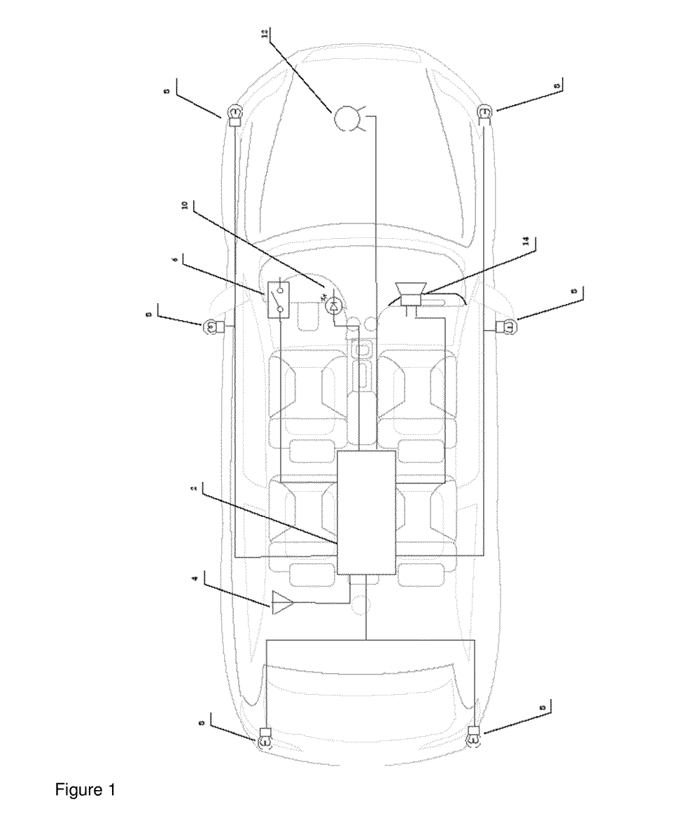

FIG. 2. The functional block diagram of the light-sound waning system of all participants in road traffic

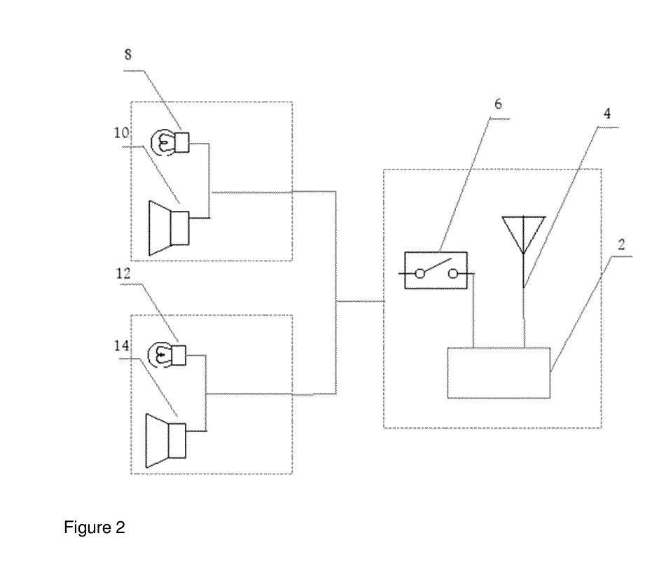

FIG. 3. Display of the light-sound warning system for all participants in road traffic

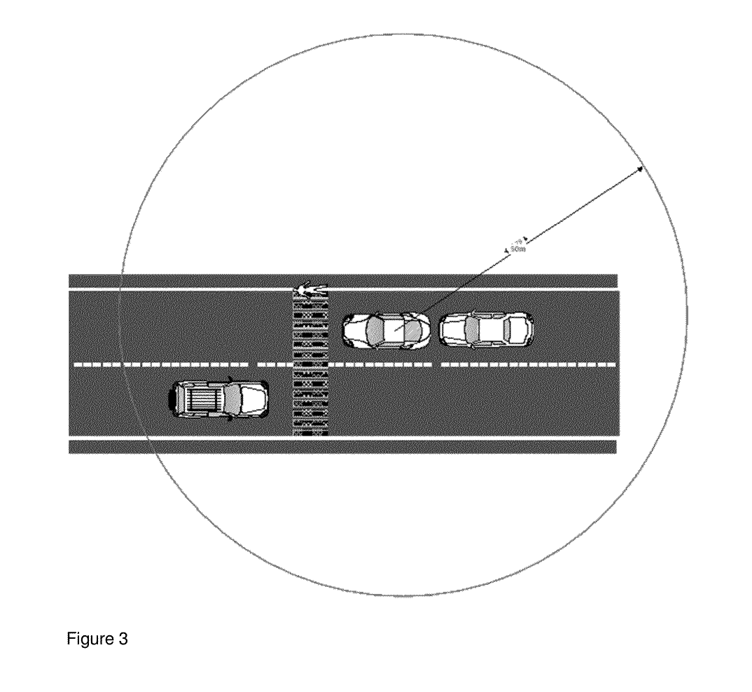

### LIST OF REFERENCE SIGNS:

2—The central unit
4—receiving-transmitting unit
6—Switch
8—External light signaling
10—Internal light signaling
12—External audio signaling
14—Internal audio signaling

### DETAILED DESCRIPTION FOR AT LEAST ONE VERSION OF INVENTION

This particular version, as described below, is not in any way limiting to the other versions of the invention.

The best performance of the light-sound warning system for all participants in road traffic is implemented in a way that incorporates the same make of the cars already in the process of production of passenger cars. In addition to the central unit (2) which is associated with the receiving-transmitting unit (4) which has the ability to send and receive signals via radio waves, providing that identical equipment is preferably installed in all vehicles, each vehicle is fitted with a switch (6) in mechanical performance, and external light signals (8), internal light signals (10), an external audio signals (12) and the internal audio signaling (14). Exterior lights (8) are installed on the passenger car towards front and back sides of vehicles, built by two separate sources of warning light in bright vibrant red color, and on each side of the car on the front fender near the door by one source of warning light bright vibrant red color. External audio signaling (12) runs the warning horn that emits the characteristic sound and the sound of constant intensity with variable frequency, with breaks at shorter intervals of 0.2 seconds. Internal audio signaling (14) is implemented through the existing vehicle audio signals, while the internal light signaling (10) in the vehicle is done by flashing red source of light on the dashboard of vehicles in the driver's field of vision. The best execution of the central unit (2) is done as a component of an existing vehicle computer, and is firmly fixed in the vicinity of receiving-transmitting unit (4), which is connected to the central unit through a wire connection. In doing so, the central unit's internal memory stores information about the time of the activation of the system. The entire system is connected to the existing power source of the vehicle, and the central unit has its own power supply system with autonomy of up to 2 hours. Receiver-transmitter unit (4) is manufactured as an integrated transmitter and receiver in VHF frequency band, with provision of sending a coded signal and being connected through a wire to an external antenna of the vehicle. Also all the other elements of the vehicle are connected with adequate wire connection.

Best version of the system for protection of participants in road traffic is that the switch (6) in the mechanical design is built into a car near the steering wheel within easy reach of the driver and it is installed on the right and left side of the handlebar. Activating of the mechanical switch (6) transmits a signal to the central unit which activates the receiving-transmitting unit (4) and transmits a radio signal to the antenna at range of approx. 70 meters from the vehicle that activated the switch. Receiver-transmitter unit (4) in the second vehicle, located at a distance of approx. 70 meters from the vehicle that has activated the switch, receives the signal and forwards it to the central unit (2) in the receiving vehicle that activates the internal light signaling (10) and the internal audio signal (14), and thus signals the driver of the vehicle the presence of pedestrians on the road. In addition to activating a mechanical switch (6) and transmitting the signal for the presence of pedestrians on the road at a distance of approx. 70 meters, the vehicle which transmits signal will activate the external light signals (8) and external audio signals (12) which signal that the pedestrian is approaching vehicle.

1. Light-sound warning system for all participants in road traffic, comprising:
central unit
the receiving-transmitting unit
a switch
external light signaling
internal light signaling
external audio signaling
internal audio signaling;
wherein all listed parts of the system are interconnected with conductive connection inside the vehicle, while the receiving-transmitting units communicate between each vehicle by transmitting signal from the vehicle in which the switch is activated to the receiver unit of the other vehicle by a radio signal.

2. The system according to claim 1 wherein a central unit receives an activation signal switch in the vehicle, and then the central unit activates the external signaling and an external sound signal.

3. The system according to claim 1, wherein the central unit receives an activation signal to the switch in the vehicle, and by the receiving-transmitting unit that transmits signals to other vehicles receiving-transmitting unit installed in other vehicles wherein then the central unit in each of the other vehicle activates the internal light signaling and the internal audio signaling.

4. The system according to claim 1, wherein the time of activation of the switch is stored in the central unit in which the vehicle is activated by the switch.

5. The system according to claim 1, wherein the time of receipt, the transmitting unit has received a signal from the second receiving-transmitting unit stored in the central unit vehicles which received the signal.

6. The system according to claim 1, wherein the external light signals running in a way that the two light sources are installed in the front and rear corners of the vehicle, while the additional light source is mounted in the sides of the vehicle.

7. The system according to claim 1, wherein the internal light signaling performed in a manner that the light source is installed inside the vehicle in the driver's field of vision.

8. The system according to claim 1, wherein the interior audio signaling integrated in the existing system audio signaling vehicles.

9. The system according to claim 1, wherein the switch is installed on the steering wheel.
